(19) United States
(12) Patent Application Publication
(10) Pub. No.: US 2012/0321749 A9
(43) Pub. Date: Dec. 20, 2012

(54) TOPICALLY SEASONED TACO SHELLS

(76) Inventors: David Hadi Youssefi, Scottsdale, AZ (US); Lawrence Martin Cuculic, Scottsdale, AZ (US)

(21) Appl. No.: 13/024,268

(22) Filed: Feb. 9, 2011

(51) Int. Cl. A47J 36/00; A23P 1/08; A21D 13/00

(52) U.S. Cl. 426/93; 426/289; 99/355

(57) ABSTRACT

Food articles comprising topically seasoned taco shells, and methods and apparatuses for producing topically seasoned taco shells.

### TECHNICAL FIELD

The present invention relates to taco shells. More specifically, the present invention relates to taco shells that are topically coated with a flavored seasoning, and methods and apparatuses for preparing taco shells that are topically coated with a flavored seasoning.

### BACKGROUND

Potato chips that are covered in a flavored seasoning are very popular among consumers. Examples include chips covered in “nacho cheese,” “ranch”, “barbeque” and other flavored powders. Generally, potato chips are fried and then seasoned by placing the snacks in a rotating tumbler that dispenses the flavoring agent, as described in U.S. Pat. No. 5,298,274 METHODS FOR MAKING TORTILLA CHIPS AND TORTILLA CHIPS PRODUCED THEREBY, Khalsa.

Taco shells of varying shapes and flavors are also quite popular. U.S. patent application Ser. No. 12/044,520 FLAVORED TACO SHELLS discusses various shapes of taco shells that have become popular, along with the use of corn tortillas made from flavored dough that is fried or baked.

There is, however, an unfulfilled need in the art for taco shells that, like their potato chip counterparts, are topically coated with flavored seasonings. As noted in “Attack of the New Snack Seasonings,” Deb North, Food Product Design 2007, consumers today are evermore drawn to all manner of novel combinations of various snack foods with flavored coatings that are topically applied. For example, tortilla chips are often matched with different types of cheesy and spicy topical powders. Id. But, to date, nobody has paired such topical flavor seasonings with taco shells. The taco shell market has thus failed to tap into new marketing opportunities, product lines, and consumer demand for new combinations of cooked food items with topical coatings.

### BRIEF SUMMARY

One aspect of the present invention is a taco shell to which a flavored seasoning has been topically applied.

Another aspect of the present invention is a taco shell to which a flavored seasoning has been topically applied to only the interior surface of the shell.

Another aspect of the present invention is a taco shell to which a flavored seasoning has been applied to only the exterior surface of the shell.

Another aspect of the present invention is a method of preparing a taco shell wherein a flavored seasoning is topically applied to the shell after the taco shell has been cooked.

Another aspect of the present invention is an apparatus for topically applying flavored seasonings to a taco shell.

Another aspect of the present invention is an apparatus for topically applying flavored seasonings to only the interior surface of a taco shell.

Another aspect of the present invention is an apparatus for topically applying flavored seasonings to only the exterior surface of a taco shell.

### BRIEF DESCRIPTION OF THE DRAWING FIGURES

Exemplary embodiments will hereinafter be described in conjunction with the following drawing figures, wherein like numerals denote like elements, and

FIG. 1 is a taco shell to which a flavored seasoning has been topically applied;

FIG. 2 is a flowchart showing a method of preparing a taco shell wherein a flavored seasoning is topically applied to the shell after the shell has been cooked; and

FIG. 3 is an apparatus for topically applying a flavored seasoning to a taco shell.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

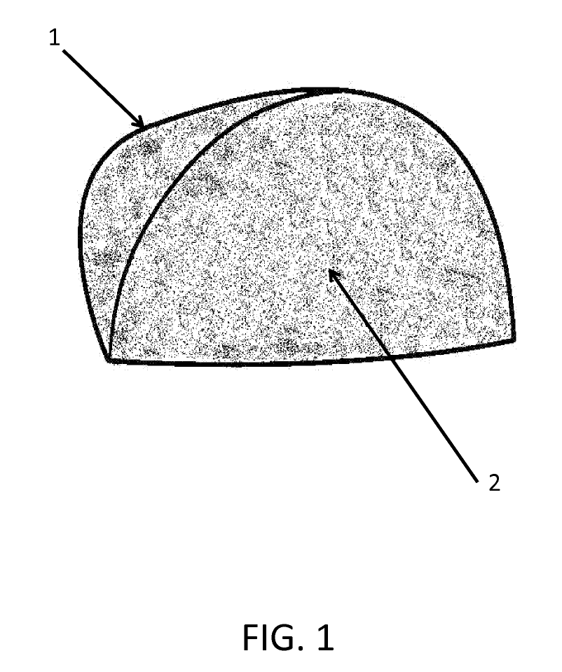

Turning now to the drawing figures and with initial reference to FIG. 1, an exemplary embodiment of the present invention is a taco shell 1 that has been topically coated with a flavored seasoning 2.

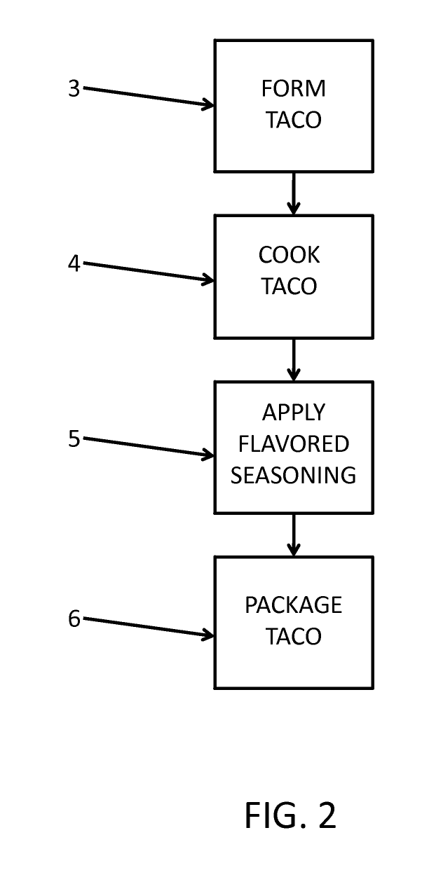

Turning now to FIG. 2, an exemplary method for producing a topically flavored taco shell comprises a first step of forming a tortilla, for example, a flour or corn tortilla, into a U shape or some other shape conducive to holding taco fillings such as meat and cheese (block 3). The folded tortilla may then be cooked in a cooking apparatus, for example, a frying vat for frying the shell in oil or an oven for baking the shell (block 4). Such cooking apparatuses are well known in the art. Once the tortilla has been cooked, taco shell 1 may take the form of a substantially rigid food article, although a “soft” taco shell 1 may also be produced by the cooking process. A flavored seasoning, or a mix of flavored seasonings, may then be topically applied to the interior and/or exterior surfaces of taco shell 1 (block 5). Taco shell 1 may then be packaged for distribution (block 6).

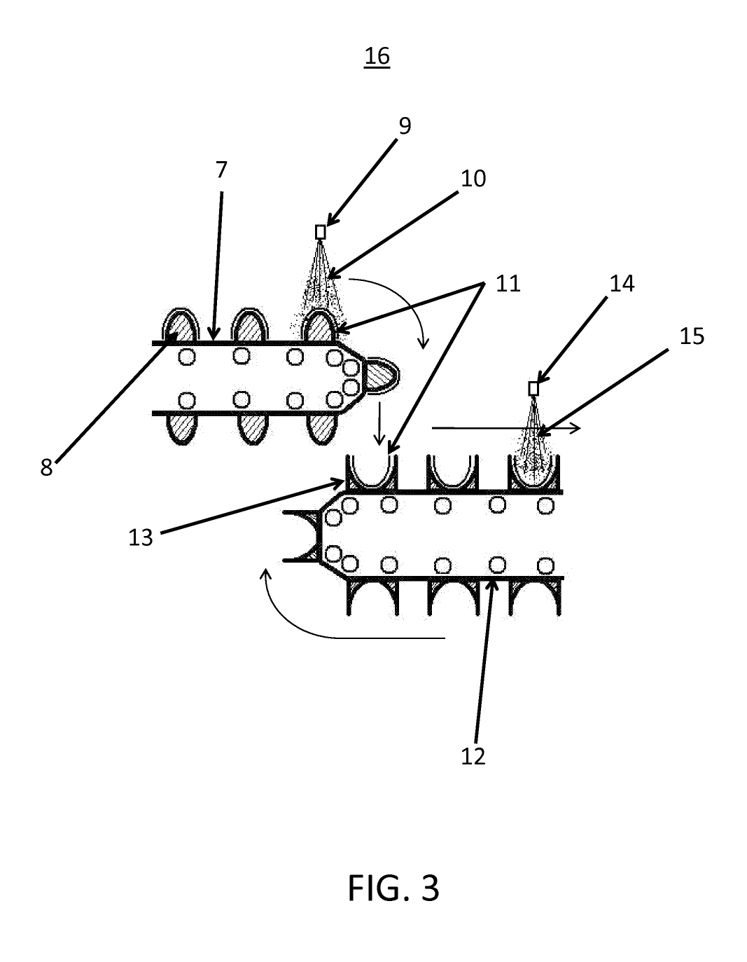

Turning now to FIG. 3, an exemplary apparatus 16 for producing a topically seasoned taco shell 1 may comprise a first conveyor apparatus 7 to which an inverted taco shell mold 8 is attached. Inverted taco shell mold 8 holds a cooked taco shell 11 in place with its outer surface exposed while conveyor apparatus 7 moves cooked taco shell 11 into proximity of seasoning dispenser 9. In one embodiment, flavored seasoning dispenser 9 shakes or otherwise dispenses flavored seasoning m onto the outer surface of cooked taco shell 11. In another embodiment, the flavored seasoning dispenser 9 consists of a pressure dispenser that sprays flavored seasoning 10 onto cooked taco shell 11. To produce a cooked taco shell 11 that does not have a flavored seasoning topically applied to its outer surface, apparatus 16 may be configured so that seasoning dispenser 9 does not release a flavored seasoning.

Cooked taco shell 11 may then be transferred to conveyor apparatus 12. In one preferred embodiment, as illustrated in FIG. 3, cooked taco shell 11 drops from conveyor apparatus 7 to conveyor apparatus 12. Taco mold 13, which is attached to conveyor apparatus 12, holds cooked taco shell 11 such that its interior surface is exposed. Conveyor apparatus 12 then moves cooked taco shell 11 into proximity of flavored seasoning dispenser 14. Seasoning dispenser 14 may shake or otherwise dispense flavored seasoning 15 onto the interior surface of cooked taco shell 11, or it may consist of a pressure dispenser that sprays flavored seasoning 15 onto the interior surface of cooked taco shell 11. To produce a cooked taco shell 11 that does not have a flavored seasoning topically applied its interior surface, apparatus 16 may be configured so that seasoning dispenser 14 does not release a flavored seasoning.

Flavored seasonings 10 and 15 may be the same or different flavored seasonings. Either flavored seasoning may be a flavor such as “nacho cheese,” “salsa,” “guacamole,” “sour cream,” “japapeno,” “chipotle,” “habanero,” “taco,” “ranch,” “cheddar,” “onion,” “bean,” “garlic,” “picante,” or some combination or variation thereof. More than one flavored seasoning may be used, and other flavors and flavor combinations may be applied to cooked taco shell 11.

The above-described embodiments of the invention are presented for purposes of illustration and not of limitation.

As used herein, the word “exemplary” means “serving as an example, instance, or illustration.” Any implementation described herein as exemplary is not to be construed as preferred or advantageous over other implementations.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A consumable food article comprising:
a taco shell; and
a flavored seasoning topically applied to at least one surface of said taco shell.

2. The consumable food article of claim 1, wherein the flavored seasoning is applied to an exterior surface of said taco shell.

3. The consumable food article of claim 1, wherein the flavored seasoning is applied to an interior surface of said taco shell.

4. The consumable food article of claim 1, wherein the flavored seasoning is applied to only an exterior surface of said taco shell.

5. The consumable food article of claim 1, wherein the flavored seasoning is applied to only an interior surface of said taco shell.

6. The consumable food article of claim 1, wherein the topically applied seasoning comprises at least one of the following group of flavorings:
nacho cheese, salsa, guacamole, sour cream, japapeno, chipotle, habanero, taco, ranch, cheddar, onion, bean, garlic, and picante.

7. A method for producing a topically seasoned taco shell comprising the steps of:
forming a tortilla into a taco shape;
cooking the tortilla; and
topically applying a flavored seasoning to the cooked taco shell.

8. The method of claim 7, wherein the flavored seasoning is applied to an interior surface of the cooked taco shell.

9. The method of claim 7, wherein the flavored seasoning is applied to an exterior surface of the cooked taco shell.

10. The method of claim 7, wherein the flavored seasoning is applied to only an interior surface of the cooked taco shell.

11. The method of claim 7, wherein the flavored seasoning is applied to only an exterior surface of the cooked taco shell.

12. The method of claim 7, wherein the topically applied seasoning comprises at least one of the following group of flavorings:
nacho cheese, salsa, guacamole, sour cream, japapeno, chipotle, habanero, taco, ranch, cheddar, onion, bean, garlic, and picante.

13. An apparatus for producing a topically seasoned taco shell comprising:
a cooking apparatus for cooking the taco shell; and
a seasoning dispenser for applying a flavored seasoning to at least one surface of the cooked taco shell.

14. The apparatus of claim 13, wherein said seasoning dispenser applies a flavored seasoning to an exterior surface of the cooked taco shell.

15. The apparatus of claim 13, wherein said seasoning dispenser applies a flavored seasoning to an interior surface of the cooked taco shell.

16. The apparatus of claim 13, wherein said seasoning dispenser applies a flavored seasoning to only an exterior surface of the cooked taco shell.

17. The apparatus of claim 13, wherein said seasoning dispenser applies a flavored seasoning to an only interior surface of the cooked taco shell.

18. The apparatus of claim 13, further comprising:
a second seasoning dispenser for applying a flavored seasoning to at least one surface of the cooked taco shell.

19. The apparatus of claim 13, wherein the cooking apparatus is a frying vat.

20. The apparatus of claim 13, wherein the cooking apparatus is an oven.
